(19) United States
(12) Patent Application Publication
(10) Pub. No.: US 2011/0261088 A1
(43) Pub. Date: Oct. 27, 2011

(54) DIGITAL CONTROL OF ANALOG DISPLAY ELEMENTS

(75) Inventors: Jae Hyeong Seo, Pleasanton, CA (US); Marc M. Mignard, San Jose, CA (US); Alok Govil, Santa Clara, CA (US); Russel A. Martin, Mento Park, CA (US)

(73) Assignee: QUALCOMM MEMS Technologies, Inc., San Diego, CA (US)

(21) Appl. No.: 13/049,812

(22) Filed: Mar. 16, 2011

Related U.S. Application Data
(60) Provisional application No. 61/326,992, filed on Apr. 22, 2010.

(51) Int. Cl. G09G 5/10; G09G 5/00

(52) U.S. Cl. 345/690; 345/211

(57) ABSTRACT

This disclosure provides methods, systems, and apparatus, including computer programs encoded on computer storage media, for controlling analog display elements. In one aspect, a control scheme can be used for controlling analog display elements, including interferometric modulators. This control scheme can be used to drive the analog display elements to a plurality of discrete different states, and can be referred to as “digital” control of the display element state.

### CROSS-REFERENCE TO RELATED APPLICATIONS

This disclosure claims priority to U.S. Provisional Application No. 61/326,992, filed Apr. 22, 2010, entitled “DIGITAL CONTROL OF ANALOG DISPLAY ELEMENTS,” and assigned to the assignee hereof. The disclosure of the prior application is considered part of, and is incorporated by reference in, this disclosure.

### TECHNICAL FIELD

This disclosure relates to electromechanical systems, and more particularly to control of analog display elements in display devices.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or morel. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

One type of IMOD includes an analog IMOD where the position of one plate in relation to another is able to be changed across a continuous range of distances. Controlling such analog IMODs may require high-precision drivers that can vary the state of the analog IMOD to any state. These drivers may control the charge applied to each analog IMOD to change the state of the IMOD. However, such drivers may be expensive and lead to issues with parasitic capacitance.

### SUMMARY

The systems, methods and devices of the disclosure each have several innovative aspects, no single one of which is solely responsible for the desirable attributes disclosed herein.

One innovative aspect of the subject matter described in this disclosure provides a system for digitally controlling a display element. The system includes a display element having a plurality of states. Each of the plurality of states corresponds to one of a plurality of charge levels applied to the display element. The system further includes a plurality of capacitors each selectively coupled to the display element. The system further includes a voltage source coupled to the display element via the selectively coupled plurality of capacitors. A charge level applied to the display element is based at least in part on the applied voltage and on which of the plurality of capacitors are coupled to the display element. Each of the plurality of capacitors may be arranged in parallel with one another. Each of the plurality of capacitors may be arranged in series with the display element. Each of the plurality of capacitors can be selectively coupled to the display element through a switch.

Another aspect of the disclosure provides a method of digitally controlling a display element. The method includes selectively coupling a plurality of capacitors to a display element having a plurality of states. Each of the plurality of states corresponds to one of a plurality of charge levels applied to the display element. The method further includes applying a voltage to the display element via the selectively coupled plurality of capacitors. A charge level applied to the display element is based at least in part on the applied voltage and on which of the plurality of capacitors are coupled to the display element. Each of the plurality of capacitors may be arranged in parallel with one another. Each of the plurality of capacitors may be arranged in series with the display element. The method may further include selectively coupling the plurality of capacitors to the display element through a plurality of switches.

Yet another aspect of the disclosure provides a system for digitally controlling a display element. The system includes means for selectively coupling a plurality of capacitors to a display element having a plurality of states. Each of the plurality of states corresponds to one of a plurality of charge levels applied to the display element. The system further includes means for applying a voltage to the display element via the selectively coupled plurality of capacitors. A charge level applied to the display element is based at least in part on the applied voltage and which of the plurality of capacitors are coupled to the display element. Each of the plurality of capacitors may be arranged in parallel with one another. Each of the plurality of capacitors may be arranged in series with the display element. The coupling means may include a plurality of switches.

Another aspect of the disclosure provides a computer-readable storage medium that includes instructions that, when executed, cause a processor to perform a method. The method includes selectively coupling a plurality of capacitors to a display element having a plurality of states, each of the plurality of states corresponding to one of a plurality of charge levels applied to the display element. The method further includes applying a voltage to the display element via the selectively coupled plurality of capacitors, wherein a charge level applied to the display element is based at least in part on the applied voltage and on which of the plurality of capacitors are coupled to the display element. Each of the plurality of capacitors may be arranged in parallel with one another. Each of the plurality of capacitors may be arranged in series with the display element. The method may further include selectively coupling the plurality of capacitors to the display element through a plurality of switches.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1A and 1B show examples of isometric views depicting a pixel of an interferometric modulator (IMOD) display device in two different states.

FIG. 2 shows an example of a schematic circuit diagram illustrating a driving circuit array for an optical MEMS display device.

FIG. 3 is an example of a schematic partial cross-section illustrating one implementation of the structure of the driving circuit and the associated display element of FIG. 2.

FIG. 4 is an example of a schematic exploded partial perspective view of an optical MEMS display device having an interferometric modulator array and a backplate with embedded circuitry.

FIG. 5 is an example of the various states of an analog interferometric modulator.

FIG. 6 is an example of an analog interferometric modulator with a control circuit.

FIG. 7 is an example of the control circuit of FIG. 6.

FIG. 8 shows an example graph of the displacement of a movable reflective layer of an interferometric modulator shown in FIG. 6.

FIG. 9 is an example schematic circuit diagram illustrating a driving circuit for an interferometric modulator shown in FIG. 6.

FIG. 10 shows an example flow diagram of a process for controlling an analog interferometric modulator in a digital mode.

FIG. 11 illustrates an example of a timing diagram for a method of addressing the interferometric modulator shown in FIG. 6.

FIGS. 12A and 12B show examples of system block diagrams illustrating a display device that includes a plurality of interferometric modulators.

FIG. 13 is an example of a schematic exploded perspective view of an electronic device having an optical MEMS display.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Systems, methods and apparatus described herein are related to analog display elements that are driven using a digital control scheme. The display elements may include IMODs. As discussed above, the state of an IMOD may be controlled by adjusting a charge on the IMOD. Analog interferometric modulators have a range of states. For example, in one implementation, a single interferometric modulator may be able to selectively reflect different wavelengths of light (e.g., red, blue, green, black, white, etc.) depending on the state of the IMOD. Each state further corresponds to a particular position of the movable layer of the IMOD with respect to the substrate. Changing the charge of the electrode moves the movable layer to different positions, and thus changes the state of the IMOD.

A method for controlling analog interferometric modulators involves using high-precision drivers that can vary the state of the analog IMOD to any state. These drivers may control the charge applied to each analog IMOD to change the state of the IMOD. However, such drivers may be expensive and lead to issues with parasitic capacitance.

Particular implementations of the subject matter described in this disclosure can be implemented to realize one or more of the following potential advantages, such as precise control of IMOD states with an inexpensive and reliable circuit. The configurations of the devices and methods described herein are described with respect to optical MEMS devices, particularly interferometric modulator display devices. However, a person/one having ordinary skill in the art will recognize that similar devices and methods may be used with other appropriate display technologies.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

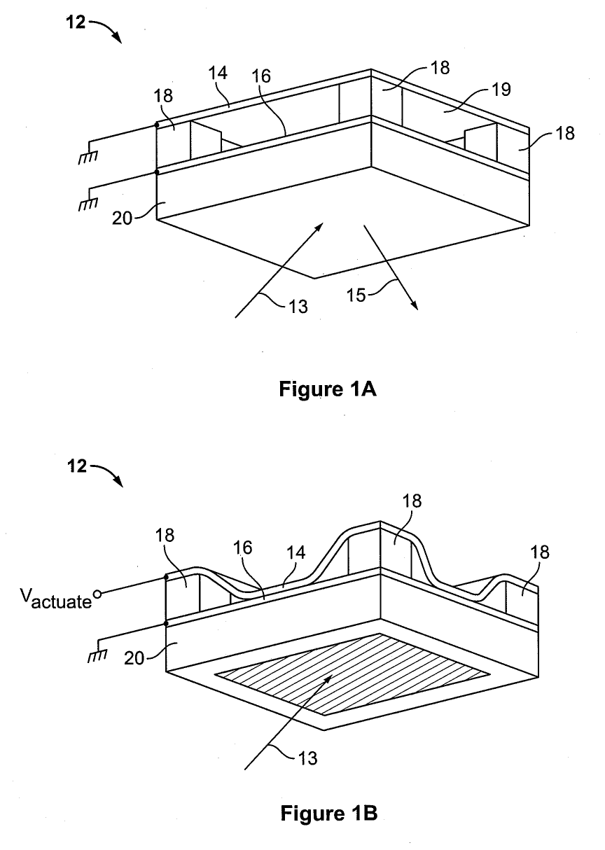

FIGS. 1A and 1B show examples of isometric views depicting a pixel of an interferometric modulator (IMOD) display device in two different states. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted pixels in FIGS. 1A and 1B depict two different states of an IMOD 12. In the IMOD 12 in FIG. 1A, a movable reflective layer 14 is illustrated in a relaxed position at a predetermined (e.g., designed) distance from an optical stack 16, which includes a partially reflective layer. Since no voltage is applied across the IMOD 12 in FIG. 1A, the movable reflective layer 14 remained in a relaxed or unactuated state. In the IMOD 12 in FIG. 1B, the movable reflective layer 14 is illustrated in an actuated position and adjacent, or nearly adjacent, to the optical stack 16. The voltage V_{actuate} applied across the IMOD 12 in FIG. 1B is sufficient to actuate the movable reflective layer 14 to an actuated position.

In FIGS. 1A and 1B, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixels 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the optical stack 16, or lower electrode, is grounded at each pixel. In some implementations, this may be accomplished by depositing a continuous optical stack 16 onto the substrate 20 and grounding at least a portion of the continuous optical stack 16 at the periphery of the deposited layers. In some implementations, a highly conductive and reflective material, such as aluminum (Al), may be used for the movable reflective layer 14. The movable reflective layer 14 may be formed as a metal layer or layers deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 in FIG. 1A, with the gap 19 between the movable reflective layer 14 and optical stack 16. However, when a potential difference, e.g., voltage, is applied to at least one of the movable reflective layer 14 and optical stack 16, the capacitor formed at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 in FIG. 1B. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

In some implementations, such as in a series or array of IMODs, the optical stacks 16 can serve as a common electrode that provides a common voltage to one side of the IMODs 12. The movable reflective layers 14 may be formed as an array of separate plates arranged in, for example, a matrix form. The separate plates can be supplied with voltage signals for driving the IMODs 12.

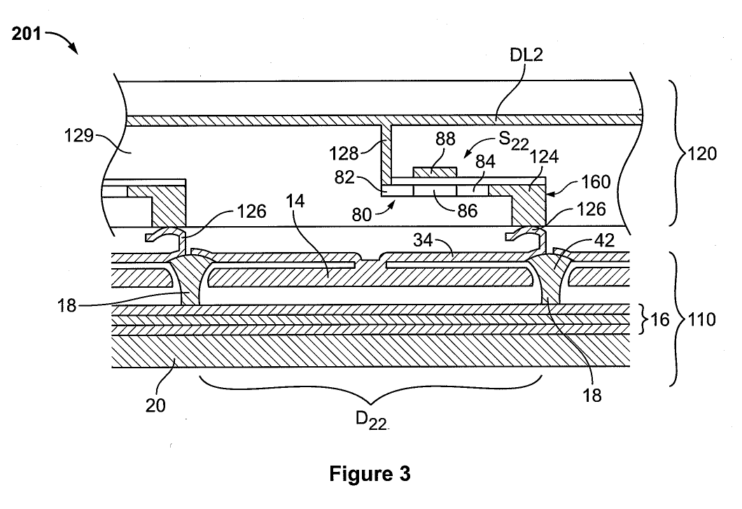

The details of the structure of interferometric modulators that operate in accordance with the principles set forth above may vary widely. For example, the movable reflective layers 14 of each IMOD 12 may be attached to supports at the corners only, e.g., on tethers. As shown in FIG. 3, a flat, relatively rigid movable reflective layer 14 may be suspended from a deformable layer 34, which may be formed from a flexible metal. This architecture allows the structural design and materials used for the electromechanical aspects and the optical aspects of the modulator to be selected, and to function, independently of each other. Thus, the structural design and materials used for the movable reflective layer 14 can be optimized with respect to the optical properties, and the structural design and materials used for the deformable layer 34 can be optimized with respect to desired mechanical properties. For example, the movable reflective layer 14 portion may be aluminum, and the deformable layer 34 portion may be nickel. The deformable layer 34 may connect, directly or indirectly, to the substrate 20 around the perimeter of the deformable layer 34. These connections may form the support posts 18.

In implementations such as those shown in FIGS. 1A and 1B, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 3) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing.

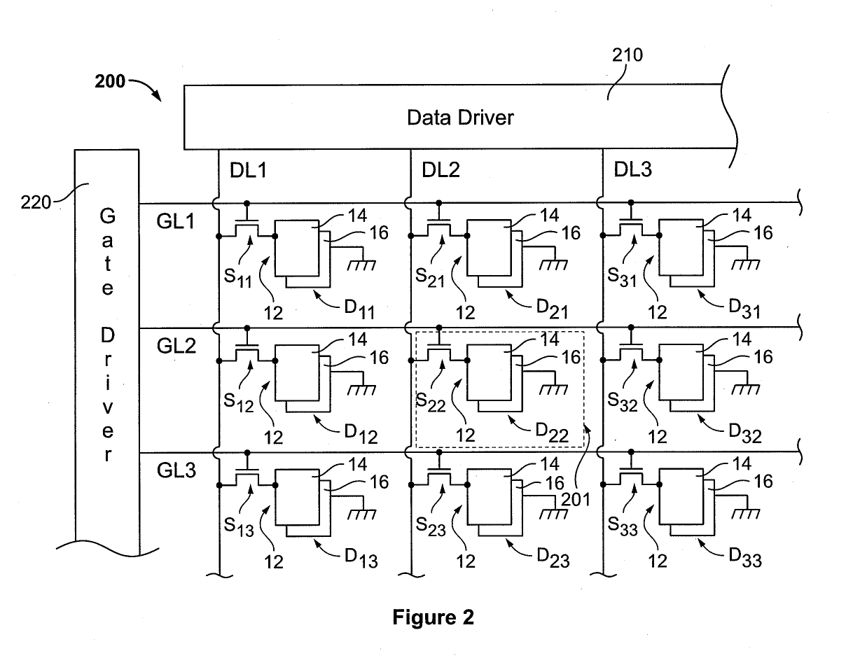

FIG. 2 shows an example of a schematic circuit diagram illustrating a driving circuit array 200 for an optical MEMS display device. The driving circuit array 200 can be used for implementing an active matrix addressing scheme for providing image data to display elements D₁₁-Dₘₙ of a display array assembly.

The driving circuit array 200 includes a data driver 210, a gate driver 220, first to m-th data lines DL1-DLm, first to n-th gate lines GL1-GLn, and an array of switches or switching circuits S₁₁-Sₘₙ. Each of the data lines DL1-DLm extends from the data driver 210, and is electrically connected to a respective column of switches S₁₁-S₁ₙ, S₂₁-S₂ₙ, . . . , Sₘ₁-Sₘₙ. Each of the gate lines GL1-GLn extends from the gate driver 220, and is electrically connected to a respective row of switches S₁₁-Sₘ₁, S₁₂-Sₘ₂, . . . , S₁ₙ-Sₘₙ. The switches S₁₁-Sₘₙ are electrically coupled between one of the data lines DL1-DLm and a respective one of the display elements D₁₁-Dₘₙ and receive a switching control signal from the gate driver 220 via one of the gate lines GL1-GLn. The switches S₁₁-Sₘₙ are illustrated as single FET transistors, but may take a variety of forms such as two transistor transmission gates (for current flow in both directions) or even mechanical MEMS switches.

The data driver 210 can receive image data from outside the display, and can provide the image data on a row by row basis in a form of voltage signals to the switches S₁₁-Sₘₙ via the data lines DL1-DLm. The gate driver 220 can select a particular row of display elements D₁₁-Dₘ₁, D₁₂-Dₘ₂, . . . , D₁ₙ-Dₘₙ by turning on the switches S₁₁-Sₘ₁, S₁₂-Sₘ₂, . . . , S₁ₙ-Sₘₙ associated with the selected row of display elements D₁₁-Dₘ₁, D₁₂-Dₘ₂, . . . , D₁ₙ-Dₘₙ. When the switches S₁₁-Sₘ₁, S₁₂-Sₘ₂, . . . , S₁ₙ-Sₘₙ in the selected row are turned on, the image data from the data driver 210 is passed to the selected row of display elements D₁₁-Dₘ₁, D₁₂-Dₘ₂, . . . , D₁ₙ-Dₘₙ.

During operation, the gate driver 220 can provide a voltage signal via one of the gate lines GL1-GLn to the gates of the switches S₁₁-Sₘₙ in a selected row, thereby turning on the switches S₁₁-Sₘₙ. After the data driver 210 provides image data to all of the data lines DL1-DLm, the switches S₁₁-Sₘₙ of the selected row can be turned on to provide the image data to the selected row of display elements D₁₁-Dₘ₁, D₁₂-Dₘ₂, . . . , D₁ₙ-Dₘₙ, thereby displaying a portion of an image. For example, data lines DL that are associated with pixels that are to be actuated in the row can be set to, e.g., 10-volts (could be positive or negative), and data lines DL that are associated with pixels that are to be released in the row can be set to, e.g., 0-volts. Then, the gate line GL for the given row is asserted, turning the switches in that row on, and applying the selected data line voltage to each pixel of that row. This charges and actuates the pixels that have 10-volts applied, and discharges and releases the pixels that have O-volts applied. Then, the switches S₁₁-Sₘₙ can be turned off. The display elements D₁₁-Dₘ₁, D₁₂-Dₘ₂, . . . , D₁ₙ-Dₘₙ can hold the image data because the charge on the actuated pixels will be retained when the switches are off, except for some leakage through insulators and the off state switch. Generally, this leakage is low enough to retain the image data on the pixels until another set of data is written to the row. These steps can be repeated to each succeeding row until all of the rows have been selected and image data has been provided thereto. In the implementation of FIG. 2, the optical stack 16 is grounded at each pixel. In some implementations, this may be accomplished by depositing a continuous optical stack 16 onto the substrate, and grounding the entire sheet at the periphery of the deposited layers.

FIG. 3 is an example of a schematic partial cross-section illustrating one implementation of the structure of the driving circuit and the associated display element of FIG. 2. A portion 201 of the driving circuit array 200 includes the switch S₂₂ at the second column and the second row, and the associated display element D₂₂. In the illustrated implementation, the switch S₂₂ includes a transistor 80. Other switches in the driving circuit array 200 can have the same configuration as the switch S₂₂, or can be configured differently, for example by changing the structure, the polarity, or the material.

FIG. 3 also includes a portion of a display array assembly 110, and a portion of a backplate 120. The portion of the display array assembly 110 includes the display element D₂₂ of FIG. 2. The display element D₂₂ includes a portion of a front substrate 20, a portion of an optical stack 16 formed on the front substrate 20, supports 18 formed on the optical stack 16, a movable reflective layer 14 (or a movable electrode connected to a deformable layer 34) supported by the supports 18, and an interconnect 126 electrically connecting the movable reflective layer 14 to one or more components of the backplate 120.

The portion of the backplate 120 includes the second data line DL2 and the switch S₂₂ of FIG. 2, which are embedded in the backplate 120. The portion of the backplate 120 also includes a first interconnect 128 and a second interconnect 124 at least partially embedded therein. The second data line DL2 extends substantially horizontally through the backplate 120. The switch S₂₂ includes a transistor 80 that has a source 82, a drain 84, a channel 86 between the source 82 and the drain 84, and a gate 88 overlying the channel 86. The transistor 80 can be, e.g., a thin film transistor (TFT) or metal-oxide-semiconductor field effect transistor (MOSFET). The gate of the transistor 80 can be formed by gate line GL2 extending through the backplate 120 perpendicular to data line DL2. The first interconnect 128 electrically couples the second data line DL2 to the source 82 of the transistor 80.

The transistor 80 is coupled to the display element D₂₂ through one or more vias 160 through the backplate 120. The vias 160 are filled with conductive material to provide electrical connection between components (for example, the display element D₂₂) of the display array assembly 110 and components of the backplate 120. In the illustrated implementation, the second interconnect 124 is formed through the via 160, and electrically couples the drain 84 of the transistor 80 to the display array assembly 110. The backplate 120 also can include one or more insulating layers 129 that electrically insulate the foregoing components of the driving circuit array 200.

The optical stack 16 of FIG. 3 is illustrated as three layers, a top dielectric layer described above, a middle partially reflective layer (such as chromium) also described above, and a lower layer including a transparent conductor (such as indium-tin-oxide (ITO)). The common electrode is formed by the ITO layer and can be coupled to ground at the periphery of the display. In some implementations, the optical stack 16 can include more or fewer layers. For example, in some implementations, the optical stack 16 can include one or more insulating or dielectric layers covering one or more conductive layers or a combined conductive/absorptive layer.

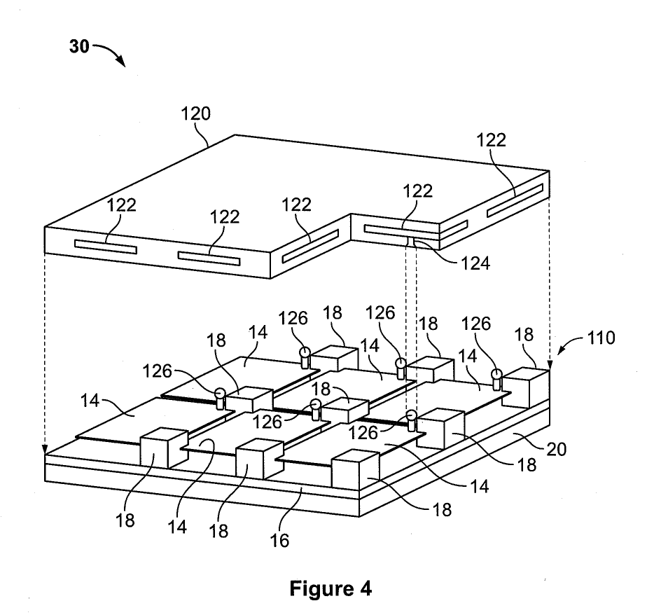

FIG. 4 is an example of a schematic exploded partial perspective view of an optical MEMS display device 30 having an interferometric modulator array and a backplate with embedded circuitry. The display device 30 includes a display array assembly 110 and a backplate 120. In some implementations, the display array assembly 110 and the backplate 120 can be separately pre-formed before being attached together. In some other implementations, the display device 30 can be fabricated in any suitable manner, such as, by forming components of the backplate 120 over the display array assembly 110 by deposition.

The display array assembly 110 can include a front substrate 20, an optical stack 16, supports 18, a movable reflective layer 14, and interconnects 126. The backplate 120 can include backplate components 122 at least partially embedded therein, and one or more backplate interconnects 124.

The optical stack 16 of the display array assembly 110 can be a substantially continuous layer covering at least the array region of the front substrate 20. The optical stack 16 can include a substantially transparent conductive layer that is electrically connected to ground. The reflective layers 14 can be separate from one another and can have, e.g., a square or rectangular shape. The movable reflective layers 14 can be arranged in a matrix form such that each of the movable reflective layers 14 can form part of a display element. In the implementation illustrated in FIG. 4, the movable reflective layers 14 are supported by the supports 18 at four corners.

Each of the interconnects 126 of the display array assembly 110 serves to electrically couple a respective one of the movable reflective layers 14 to one or more backplate components 122 (e.g., transistors S and/or other circuit elements). In the illustrated implementation, the interconnects 126 of the display array assembly 110 extend from the movable reflective layers 14, and are positioned to contact the backplate interconnects 124. In another implementation, the interconnects 126 of the display array assembly 110 can be at least partially embedded in the supports 18 while being exposed through top surfaces of the supports 18. In such an implementation, the backplate interconnects 124 can be positioned to contact exposed portions of the interconnects 126 of the display array assembly 110. In yet another implementation, the backplate interconnects 124 can extend from the backplate 120 toward the movable reflective layers 14 so as to contact and thereby electrically connect to the movable reflective layers 14.

The interferometric modulators described above have been described as bi-stable elements having a relaxed state and an actuated state. The above and following description, however, also may be used with analog interferometric modulators having a range of states. For example, an analog interferometric modulator can have a red state, a green state, a blue state, a black state and a white state, in addition to other color states. Accordingly, a single interferometric modulator can be configured to have various states with different light reflectance properties over a wide range of the optical spectrum.

This disclosure presents, among other things, systems and methods for controlling analog interferometric modulators using a stepwise control scheme. The stepwise control scheme can be used to drive the analog interferometric modulator to a plurality of different discrete states (e.g., red, blue, green, black, white, etc.), and also can be referred to herein as a “digital” control of the interferometric modulator state.

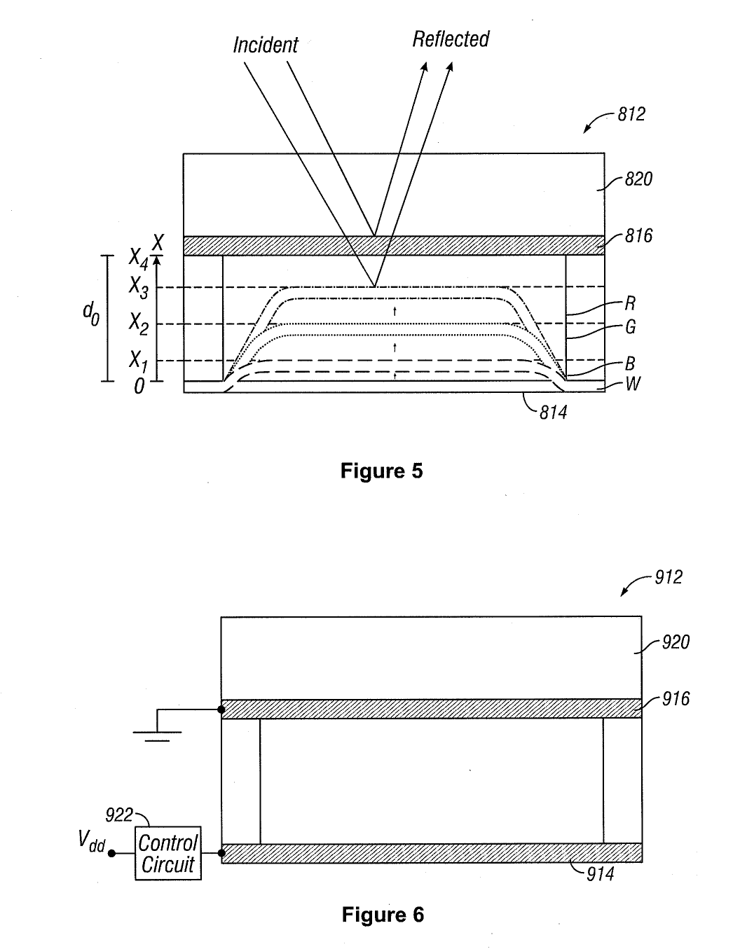

FIG. 5 shows an example of the various states of an analog interferometric modulator 812. The analog interferometric modulator 812 includes a movable reflective layer 814, an optical stack 816, and a transparent substrate 820. The movable reflective layer 814 can be moved to various positions, e.g., 0, x₁, x₂, x₃ and x₄. In some implementations, incident light reflecting from the two layers, the movable reflective layer 814 and the optical stack 816, can interfere constructively, or destructively, depending on the wavelength(s) of the incident light. The analog interferometric modulator 812 can move to and through different states depending on the reflected incident light. For example, when the movable reflective layer 814 is at position 0, all wavelengths of light incident the transparent substrate 820 may be reflected. Accordingly, because all wavelengths of light may be reflected, position 0 may correspond to a white state of the analog interferometric modulator 812. Similarly, when the movable reflective layer 814 is at position x₁, only blue wavelengths of light incident the transparent substrate 820 may be reflected. Accordingly, position x₁ may correspond to a blue state of the analog interferometric modulator 812. Further, at position x₂ green light may be reflected, at position x₃ red light may be reflected, and at position x₄ no light may be reflected, corresponding to a green state, a red state, and a black state, respectively, of the analog interferometric modulator 812.

In some implementations, the position of the movable layer 814 may be controlled by changing the charge of the capacitor formed by the movable reflective layer 814 and the optical stack 816. The change in charge can cause the movable reflective layer 814 to move to different positions, and thus to different states.

In some implementations, the movable reflective layer 814 can be moved according to the structures and methods described below with respect to FIGS. 6-11.

It should be noted that a person/one having ordinary skill in the art will readily recognize that the analog interferometric modulator 812 can take on different states and selectively reflect other wavelengths of light or combinations of wavelengths of light depending on the materials used in construction of the analog interferometric modulator 812 and the position of the movable reflective layer 814.

FIG. 6 is an example of an analog interferometric modulator 912 with a control circuit 922. In some implementations, the analog interferometric modulator 912 may be configured like the analog interferometric modulator 812. Modulator 912 includes a movable reflective layer 914, an optical stack 916 and a transparent substrate 920. The control circuit 922 can be configured to provide digital control of the analog interferometric modulator 912.

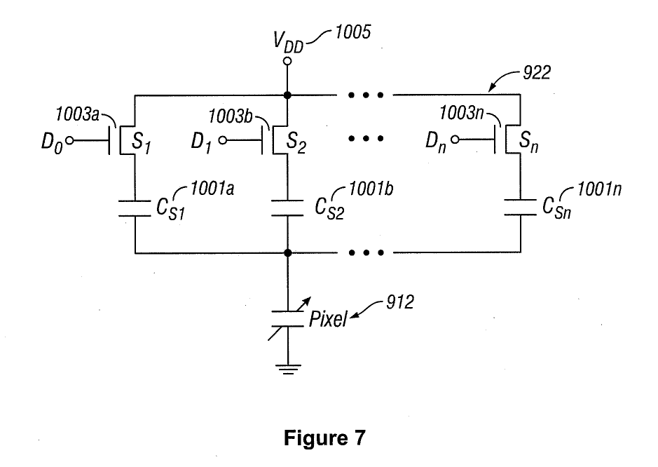

FIG. 7 is an example of the control circuit 922 of FIG. 6. The control circuit 922 can be configured to apply different charges to the analog interferometric modulator 912, wherein each charge level can correspond to a different state. Control circuit 922 includes multiple capacitors 1001a-n connected in parallel to each other. The multiple capacitors 1001a-n are also connected in series with the analog interferometric modulator 912 via switches 1003a-n. In some implementations, at least one capacitor 1001a-n can have a different capacitance than one of the other capacitors 1001a-n. In other implementations, two or more of the capacitors 1001a-n can have the same capacitance. In another implementation, each of the capacitors 1001a-n can have a different capacitance. The selection of capacitor values and the number of capacitors selected may be based on the desired functionality of the analog interferometric modulator 912 as discussed further below.

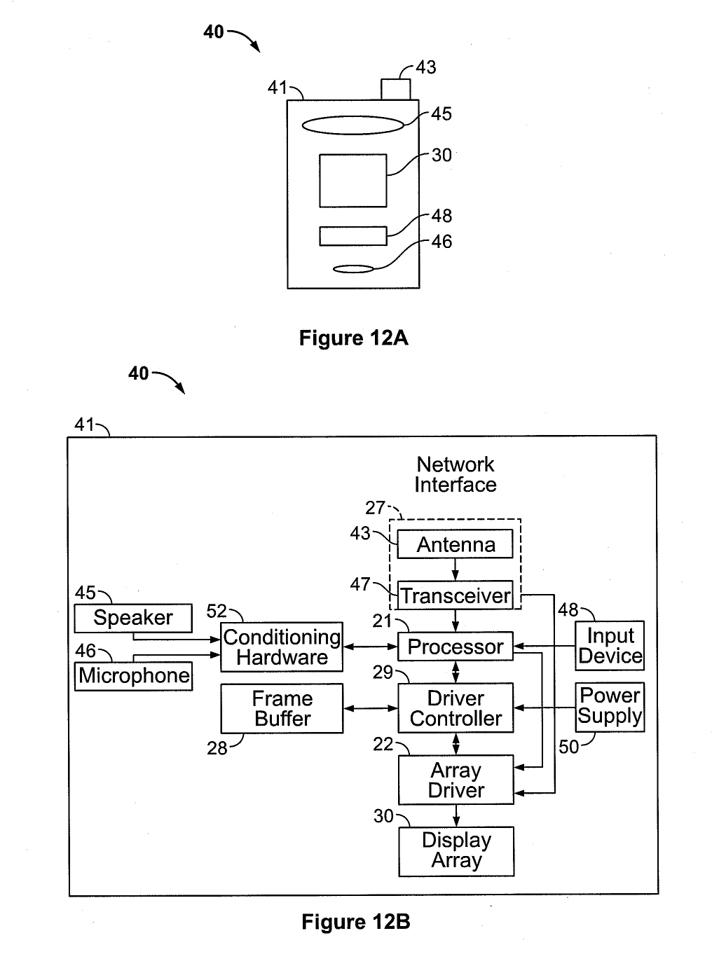

Each one of the switch 1003a-n can be serially connected with one of the capacitors 1001a-n. Switches 1003a-n may include single transistors as shown, dual transistor gates for bidirectional current flow, or any other switching circuit. Switches 1003a-n may be used to selectively couple or decouple each respective capacitor 1001a-n from the interferometric modulator 912. The opening and closing of the switches 1003a-n may be controlled, for example, by one or more of the processor 21, driver controller 29, and/or array driver 22, e.g., shown below in FIG. 12B. In some implementations, the opening and closing of the switches 1003a-n may be controlled by the data driver 210 of FIG. 2.

The capacitors 1001a-n and switches 1003a-n can be further coupled to a voltage source 1005. The voltage source 1005 may be connected in series with the capacitors 1001a-n and the switches 1003a-n. The voltage source 1005 may be used to supply a voltage across the capacitors 1001a-n and the interferometric modulator 912. In some implementations, the array driver 22 as shown below in FIG. 12B can be configured to be the voltage source 1005.

Since the position of the movable reflective layer 914 is based on the charge on the capacitor formed by the movable reflective layer 914 and the optical stack 916, the state of the analog interferometric modulator 912 is also based on the capacitor's charge. Adjusting the effective capacitance of the control circuit 922 can change the charge of the interferometric modulator 912 when a constant voltage is applied by the voltage source 1005. Therefore, the charge of the analog interferometric modulator 912 can be based on the selective coupling and decoupling of the capacitors 1001a-n to/from the analog interferometric modulator 912.

In some implementations, the selection of capacitor values and the number of capacitors selected for the control circuit 922 can be based on the desired functionality of the analog interferometric modulator 912. For example, it may be desirable to have a control circuit 922 that is configured to drive the interferometric modulator 912 to a plurality of specific states, such as a red state, a green state, a blue state and a black state. In some implementations, the control circuit 922 may include three different capacitors, with each having a different capacitance, such that coupling all of the capacitors puts the interferometric modulator in a black state, coupling only a first capacitor 1001a-n puts the interferometric modulator in a red state, coupling only a second capacitor 1001a-n puts the interferometric modulator in a green state, and coupling only a third capacitor 1001a-n puts the interferometric modulator in a blue state.

In some implementations, the values of the capacitors 1001a-n may be selected such that the effective capacitance values of the control circuit 922 are evenly spaced. For example, the capacitance values of each capacitor 1001a-n may be equal to (2^{x})*C, for a number X of capacitors 1001a-n, wherein x=0 to (X−1), where X is a positive integer. Accordingly, for a three capacitor control circuit 922, the capacitor values could be C, 2C and 4C. The capacitance values that can be achieved by the various combinations of coupling and decoupling the three capacitors of values C, 2C and 4C are evenly spaced as 0, C, 2C, 3C, 4C, 5C, 6C and 7C. These are the total capacitance values for the eight different open/closed configurations of three switches connected to capacitance values of C, 2C, and 4C.

Because the analog interferometric modulator 912 can store different charge levels, the analog IMOD 912 can be driven to different states. The charge can be supplied by the voltage source 1005 connected in series with the capacitors 1001a-n. Interferometric modulator 912, which includes a movable electrode and a stationary electrode in parallel to each other, can act as a variable capacitor that stores charge. The charge Q stored by the interferometric modulator 912 can be modeled by equation (1) as follows:

Q=V_{dd}*(CᵢCₛ)/(Cᵢ+Cₛ) (1)

where,

V_{dd}=the voltage applied by the voltage source 1005;

Cᵢ=the capacitance of the interferometric modulator 912; and

Cₛ=the effective capacitance of the control circuit 922.

In a circuit with multiple capacitors connected in parallel, the effective capacitance Cₛ is equal to the sum of the capacitance of each individual capacitor that has been switched on.

As discussed above with respect to FIGS. 5 and 6, the position of the movable reflective layer 914 is related to the charge on the analog interferometric modulator 912. This position can described as the distance x that the movable reflective layer 914 moves from a relaxed state (shown as d₀ in FIG. 5) toward the optical stack 916. The distance x can be modeled by equation (2) as follows:

x=Q²/(2kA∈) (2)

where,

Q=the charge on the interferometric modulator 912;

k=the mechanical spring constant of the movable reflective layer 914 (assuming that F=kx where F is the force applied to the movable reflective layer 914);

A=the surface area of the movable reflective layer 914; and

∈=the permittivity of the material between the movable reflective layer 914 and the optical stack 916.

Since the distance between the movable reflective layer 914 and the optical stack 916 changes depending on the state of the interferometric modulator 912 (which is dependent on the charge of the interferometric modulator 912), the capacitance Cᵢ of the interferometric modulator 912 also changes based on the state. The capacitance Cᵢ can be modeled by equation (3) as follows:

Cᵢ=C_{UP}/(1−(x/d₀)) (3)

where,
C_{UP}=the capacitance of the interferometric modulator 912 when the movable reflective layer 914 is in the relaxed state;
x=the distance the movable reflective layer 914 is moved from a relaxed state toward the optical stack 916; and
d₀=the distance between the movable reflective layer 914 and the optical stack 916 when the movable reflective layer 914 is in the relaxed state.

The capacitance C_{UP} of the interferometric modulator 912 when the movable reflective layer 914 is in the relaxed state can be calculated by equation (4) as follows:

C_{UP}=∈A/d₀ (4)

where,
∈=the permittivity of the material between the movable reflective layer 914 and the optical stack 916;
A=the surface area of the movable reflective layer 914; and
d₀=the distance between the movable reflective layer 914 and the optical stack 916 when the movable reflective layer 914 is in the relaxed state.

By utilizing equations 1-4, a relationship between the position x of the movable reflective layer 914 and the effective capacitance Cₛ of the control circuit 922 can be modeled for any given V_{dd}, C_{UP}, d₀ and k.

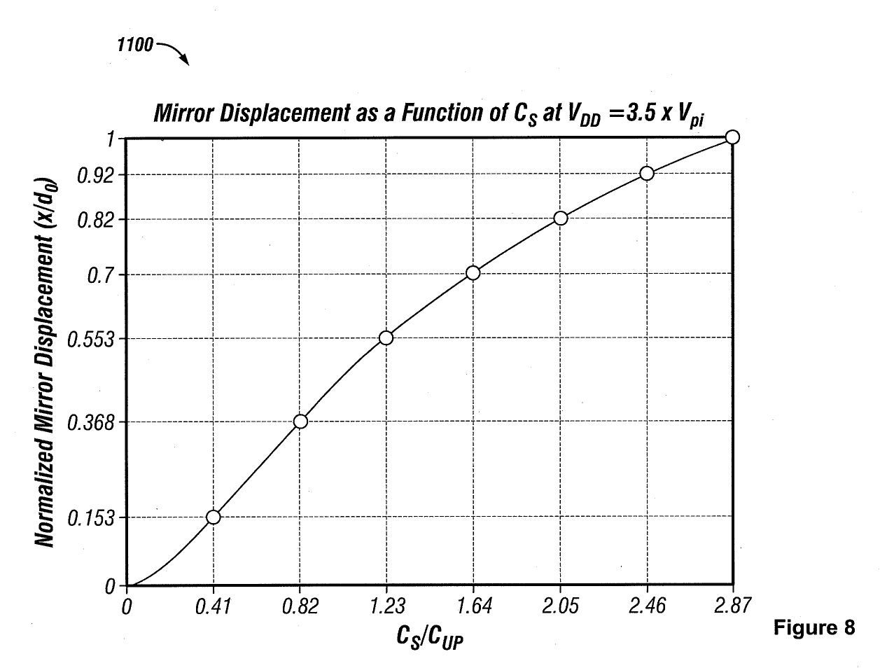

FIG. 8 shows an example graph of the displacement of a movable reflective layer of an interferometric modulator such as the one shown in FIG. 6. Utilizing the equations described above with respect to FIG. 7, the displacement of the movable reflective layer 914 with respect to the capacitance of the overall circuit including capacitors 1001a-n and the analog interferometric modulator 912 are plotted in a graph 1100 for a voltage of V_{dd}=3.5*Vₚᵢ applied to the circuit. Vₚᵢ is the “pull-in” voltage, which is the minimum voltage required to pull the moveable reflective layer 914 from an inactivated, i.e., relaxed, position to an activated position. The “pull-in” voltage is related to the variables k, ∈, A and d₀. The x-axis of the graph 1100 corresponds to the sum of the capacitors 1001a-n (assuming the respective switches 1003a-n are in the on state) that are connected to the interferometric modulator 912, divided by the capacitance C_{UP} of the interferometric modulator 912 when the movable reflective layer 914 is in the relaxed state. Further, the y-axis corresponds to the displacement x of the movable reflective layer 914, divided by the distance d₀ between the movable reflective layer 914 and the optical stack 916 when the movable reflective layer 914 is at a rest or unactuated position. As can be seen on the graph, an approximately linear relationship exists between the sum of the capacitors 1001 connected to the interferometric modulator 912 (shown on the x-axis) and the displacement of the movable electrode 914, and as a corollary, the state of the interferometric modulator 912 (shown on the y-axis). Because the charge is being controlled, the relationship can be fairly linear, as compared to voltage control.

A person/one having ordinary skill in the art will recognize that each capacitor 1001a-n may be coupled or decoupled from the interferometric modulator 912. Therefore, each capacitor 1001a-n may provide two different capacitances to the control circuit 922, one where the capacitor 1001a-n is coupled to the interferometric modulator 912, and one where the capacitor 1001a-n is not coupled to the interferometric modulator 912. Therefore, for X number of capacitors 1001a-n, there are 2^{X} combinations of coupling and decoupling capacitors 1001a-n, where X is a positive integer, and where two represents the number of capacitances that may be provided by each capacitor. In the case where each capacitor has a different capacitance, there are therefore 2^{X} capacitance levels that can be set for the circuit. This would lead to 2^{X} charge levels that are possible by switching the switches 1003a-n open and closed selectively. Accordingly, the analog interferometric modulator 912 can be driven to up to 2^{X} different states in a digital mode via the switches 1003a-n and the capacitors 1001a-n.

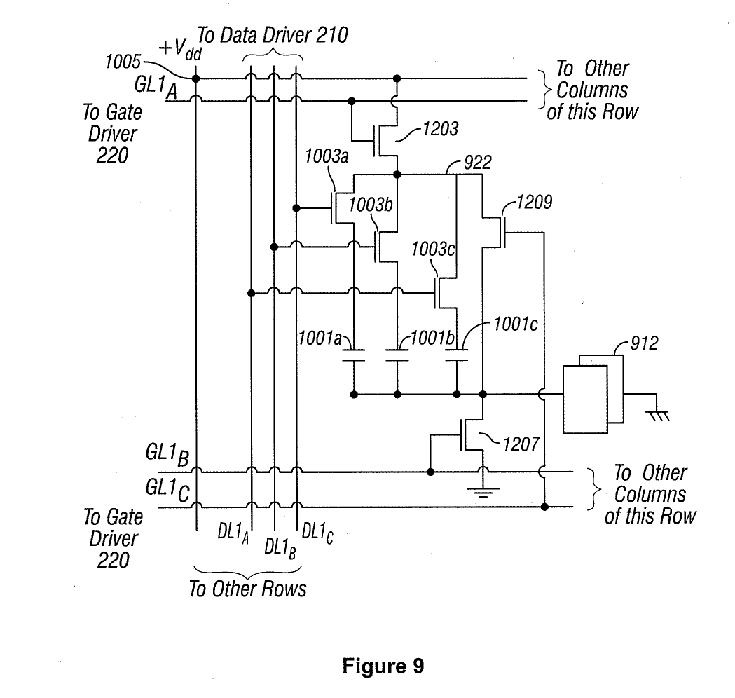

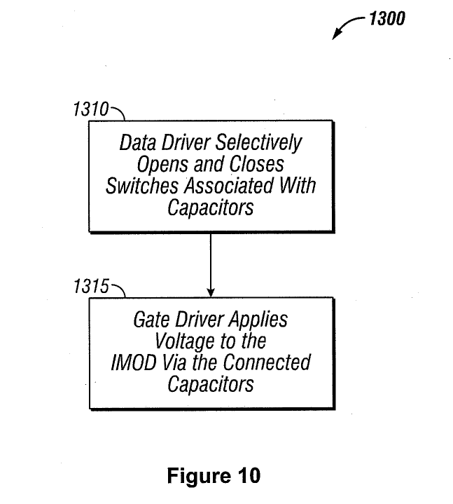

FIG. 9 is an example schematic circuit diagram illustrating a driving circuit for an interferometric modulator, such as the one shown in FIG. 6. The interferometric modulator 912 can be controlled in a digital mode according to the process 1300 shown in FIG. 10 and can utilize the driving circuit shown in FIG. 9. FIG. 9 shows one IMOD pixel in an array similar to FIG. 2, except there are three data lines per column—one for each capacitor switch—plus an additional V_{dd} input.

FIG. 10 shows an example flow diagram of a process for controlling an analog interferometric modulator in a digital mode. Referring now also to FIG. 10, in block 1310, the data driver 210 sends one or more signals to the switches 1003a-c selectively closing and opening the switches 1003a-c. The data lines can be configured such that the switches 1003a-c are opened and closed to achieve a particular state of the interferometric modulator 912. Each of the switches 1003a-c can be connected to the data driver 210 via a data line (e.g., data lines DL1_{A}, DL1_{B} and DL1_{C}). Accordingly, the data driver 210 may be configured to control an entire array of interferometric modulators 912 using the process 1300.

In block 1315, the gate driver 220 applies a voltage to a gate line GL1_{A}. The voltage applied to the gate line GL1_{A} causes a switch 1203 to close, thus connecting the control circuit 922 to the voltage source 1005. Accordingly, a voltage is applied to the interferometric modulator 912 via the control circuit 922, setting the interferometric modulator 912 to the desired state as discussed above.

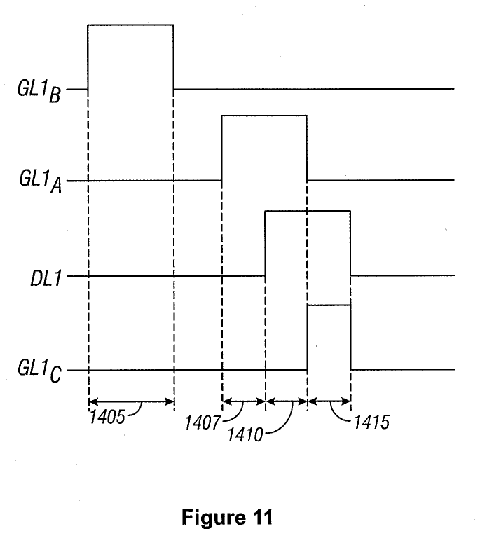

The driving circuit shown in FIG. 9 further includes a switch 1207 and a switch 1209. The switch 1207 is configured to reset the interferometric modulator 912 to a relaxed state. The switch 1209 is configured to discharge the capacitors 1001. The control of switches 1207 and 1209 to perform the recited functions is discussed below with respect to FIG. 11.

FIG. 11 illustrates an example of a timing diagram for a method of addressing the interferometric modulator 912 shown in FIGS. 6, 7 and 9. Referring to both FIGS. 11 and 9, during a time period 1405, a voltage is applied to a gate line GL1_{B}. When a voltage is applied to the gate line GL1_{B}, the switch 1207 closes. The closing of switch 1207 grounds the interferometric modulator 912. Accordingly, any stored charge on the interferometric modulator 912 dissipates to ground and the stored charge goes to zero, thus placing the interferometric modulator 912 in a relaxed state. At the end of the time period 1405, the voltage is no longer applied to the gate line GL1_{B} and switch 1207 opens.

In some implementations, the gate line GL1_{B} is addressed before the row of interferometric modulators, including the interferometric modulator 912 (and the other modulators of the same row), have data written to them. Accordingly, the interferometric modulator 912 may be put in a relaxed state during the addressing of the previous row of interferometric modulators. For example, the gate line GL1_{B} may be tied to a gate line GL0_{A} (not shown), similar to the gate line GL1_{A}, except associated with the previous row of interferometric modulators. When the previous row of interferometric modulators are connected to the voltage source 1005, i.e., from a voltage applied to gate line GL0_{A}, the row of interferometric modulators associated with GL1_{B} may be configured in a relaxed state.

At a time period 1407, a voltage is applied to the gate line GL1_{A}. Again, this voltage application can cause the switch 1203 to close. Further, during the time period 1410, the data driver 210 can selectively apply a voltage to data lines DL1 to close a desired set of switches 1003, selectively coupling capacitors 1001 to the interferometric modulator 912 based on the desired state of the interferometric modulator 912. At the end of the time period 1410, when the interferometric modulator 912 reaches the desired charge level, the voltage is no longer applied to the gate line GL1_{A} and the switch 1203 opens. Next, during a time period 1415, a voltage is applied to line GL1_{C}. The voltage applied on the line GL1_{C} causes the switch 1209 to close. Accordingly, the capacitors 1001 selectively coupled by the switches 1003 are shorted and thus discharged. At the end of the time period 1415, voltage is no longer applied to data line DL1 and line GL1_{C}. The interferometric modulator 912 is thus addressed, and the capacitors 1001 are returned to a discharged state such that they can be subsequently used for a next addressing period.

FIGS. 12A and 12B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 12B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

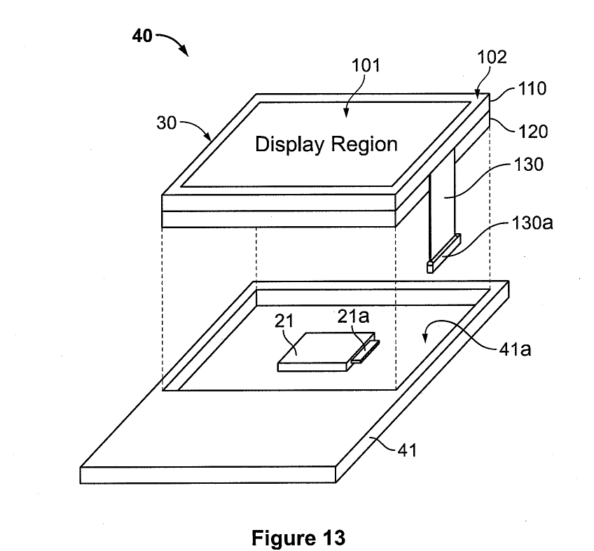

FIG. 13 is an example of a schematic exploded perspective view of the electronic device 40 of FIGS. 12A and 12B according to one implementation. The illustrated electronic device 40 includes a housing 41 that has a recess 41a for a display array 30. The electronic device 40 also includes a processor 21 on the bottom of the recess 41a of the housing 41. The processor 21 can include a connector 21a for data communication with the display array 30. The electronic device 40 also can include other components, at least a portion of which is inside the housing 41. The other components can include, but are not limited to, a networking interface, a driver controller, an input device, a power supply, conditioning hardware, a frame buffer, a speaker, and a microphone, as described earlier in connection with FIG. 12B.

The display array 30 can include a display array assembly 110, a backplate 120, and a flexible electrical cable 130. The display array assembly 110 and the backplate 120 can be attached to each other, using, for example, a sealant.

The display array assembly 110 can include a display region 101 and a peripheral region 102. The peripheral region 102 surrounds the display region 101 when viewed from above the display array assembly 110. The display array assembly 110 also includes an array of display elements positioned and oriented to display images through the display region 101. The display elements can be arranged in a matrix form. In some implementations, each of the display elements can be an interferometric modulator. Also, in some implementations, the term “display element” may be referred to as a “pixel.”

The backplate 120 may cover substantially the entire back surface of the display array assembly 110. The backplate 120 can be formed from, for example, glass, a polymeric material, a metallic material, a ceramic material, a semiconductor material, or a combination of two or more of the foregoing materials, in addition to other similar materials. The backplate 120 can include one or more layers of the same or different materials. The backplate 120 also can include various components at least partially embedded therein or mounted thereon. Examples of such components include, but are not limited to, a driver controller, array drivers (for example, a data driver and a scan driver), routing lines (for example, data lines and gate lines), switching circuits, processors (for example, an image data processing processor) and interconnects.

The flexible electrical cable 130 serves to provide data communication channels between the display array 30 and other components (for example, the processor 21) of the electronic device 40. The flexible electrical cable 130 can extend from one or more components of the display array assembly 110, or from the backplate 120. The flexible electrical cable 130 can include a plurality of conductive wires extending parallel to one another, and a connector 130a that can be connected to the connector 21a of the processor 21 or any other component of the electronic device 40.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but is to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A system for controlling a display element, the system comprising:
a display element having a plurality of states, each of the plurality of states corresponding to one of a plurality of charge levels applied to the display element;
a plurality of capacitors each selectively coupled to the display element; and
a voltage source coupled to the display element via the selectively coupled plurality of capacitors, wherein a charge level applied to the display element is based at least in part on the applied voltage and on which of the plurality of capacitors are coupled to the display element.

2. The system of claim 1, wherein the display element includes an interferometric modulator.

3. The system of claim 1, wherein the plurality of capacitors are arranged in parallel with one another.

4. The system of claim 1, wherein the plurality of capacitors are arranged in series with the display element.

5. The system of claim 1, wherein a first capacitor of the plurality of capacitors has a first capacitance and the second capacitor of the plurality of capacitors has a second capacitance that is different from the first capacitance.

6. The system of claim 1, wherein the plurality of capacitors are each selectively coupled to the display element through a switch.

7. The system of claim 6, wherein the switch includes a transistor.

8. The system of claim 1, wherein the display element is part of an array of display elements.

9. The system of claim 8, wherein an array driver is configured to control the selective coupling of the plurality of capacitors to the display element.

10. A method of controlling a display element, the method comprising:
selectively coupling a plurality of capacitors to a display element having a plurality of states, each of the plurality of states corresponding to one of a plurality of charge levels applied to the display element; and
applying a voltage to the display element via the selectively coupled plurality of capacitors, wherein a charge level applied to the display element is based at least in part on the applied voltage and on which of the plurality of capacitors are coupled to the display element.

11. The method of claim 10, wherein the display element includes an interferometric modulator.

12. The method of claim 10, wherein the plurality of capacitors are arranged in parallel with one another.

13. The method of claim 10, wherein the plurality of capacitors are arranged in series with the display element.

14. The method of claim 10, wherein a first capacitor of the plurality of capacitors has a first capacitance and the second capacitor of the plurality of capacitors has a second capacitance that is different from the first capacitance.

15. The method of claim 10, further comprising selectively coupling the plurality of capacitors to the display element through a plurality of switches.

16. The method of claim 15, wherein at least one of the plurality of switches includes a transistor.

17. The method of claim 10, wherein the display element is part of an array of display elements.

18. The method of claim 17, further comprising controlling the selective coupling of the plurality of capacitors to the display element via an array driver.

19. A system for controlling a display element, the system comprising:
means for selectively coupling a plurality of capacitors to a display element having a plurality of states, each of the plurality of states corresponding to one of a plurality of charge levels applied to the display element; and
means for applying a voltage to the display element via the selectively coupled plurality of capacitors, wherein a charge level applied to the display element is based at least in part on the applied voltage and which of the plurality of capacitors are coupled to the display element.

20. The system of claim 19, wherein the display element includes an interferometric modulator.

21. The system of claim 19, wherein the plurality of capacitors are arranged in parallel with one another.

22. The system of claim 19, wherein the plurality of capacitors are arranged in series with the display element.

23. The system of claim 19, wherein a first capacitor of the plurality of capacitors has a first capacitance and the second capacitor of the plurality of capacitors has a second capacitance that is different from the first capacitance.

24. The system of claim 19, wherein the coupling means includes a plurality of switches.

25. The system of claim 19, wherein the coupling means includes at least one transistor.

26. The system of claim 19, wherein the display element is part of an array of display elements.

27. The system of claim 26, further comprising means for controlling the selective coupling of the plurality of capacitors to the display element.

28. A computer-readable storage medium comprising instructions that, when executed, cause a processor to perform a method, the method comprising:
selectively coupling a plurality of capacitors to a display element having a plurality of states, each of the plurality of states corresponding to one of a plurality of charge levels applied to the display element; and
applying a voltage to the display element via the selectively coupled plurality of capacitors, wherein a charge level applied to the display element is based at least in part on the applied voltage and on which of the plurality of capacitors are coupled to the display element.

29. The computer-readable storage medium of claim 28, wherein the display element includes an interferometric modulator.

30. The computer-readable storage medium of claim 28, wherein the plurality of capacitors are arranged in parallel with one another.

31. The computer-readable storage medium of claim 28, wherein the plurality of capacitors are arranged in series with the display element.

32. The computer-readable storage medium of claim 28, wherein a first capacitor of the plurality of capacitors has a first capacitance and the second capacitor of the plurality of capacitors has a second capacitance that is different from the first capacitance.

33. The computer-readable storage medium of claim 28, wherein the method further includes selectively coupling the plurality of capacitors to the display element through a plurality of switches.

34. The computer-readable storage medium of claim 33, wherein at least one of the plurality of switches includes a transistor.

35. The computer-readable storage medium of claim 28, wherein the display element is part of an array of display elements.

36. The computer-readable storage medium of claim 35, wherein the method further includes controlling the selective coupling of the plurality of capacitors to the display element via an array driver.
